(19) United States
(12) Patent Application Publication
(10) Pub. No.: US 2014/0144388 A1
(43) Pub. Date: May 29, 2014

(54) COLLAPSIBLE CAT GROOMING DEVICE

(71) Applicant: WORLDWISE, INC., San Rafael, CA (US)

(72) Inventor: Sara Paculdo, San Francisco, CA (US)

(73) Assignee: WORLDWISE, INC., San Rafael, CA (US)

(21) Appl. No.: 13/689,662

(22) Filed: Nov. 29, 2012

(51) Int. Cl. A01K 13/00

(52) U.S. Cl. CPC A01K 13/004
USPC 119/622

(57) ABSTRACT

A device for facilitating a cat's self grooming. The device includes a pad for residing upon a planar surface and first and second grooming elements. The first and second grooming elements have nodules extending therefrom and each is releasably appended to the pad and to one another such that the grooming elements are selectively detachable from the pad and from each other.

### TECHNICAL FIELD

The present invention involves a cat grooming device for enabling a cat to self groom. The device is composed of individual parts which can selectively detach from one another to provide a minimum volume when shipped from its manufacturer and when displayed at retail.

### BACKGROUND OF THE INVENTION

It is well recognized that domestic cats are fastidious in grooming themselves. They often lick and scratch their own coats and rub up against furniture and other objects as a means of loosening fur, dander and the like as part of their need to self groom.

There are a number of grooming devices which have been commercialized and disclosed in the patented literature all aimed to assist cats in grooming. For example, U.S. Pat. No. 4,938,169 to Barmakiam discloses a cat grooming device which includes rows of flexible nodules intended to remove fur and dander as the pet proceeds by and rubs against them. Similarly, U.S. Pat. No. 5, 460,121 to Udelle et al. discloses a mailbox-like structure having a row of flexible nodules at its entrance intended groom a cat when entering and leaving the device. As external grooming attributes to a healthy coat and stimulates circulation, it is not surprising that devices of this nature have been of interest to pet owners over time.

Devices such as those described above generally occupy three dimensional space and tend to be somewhat bulky. However, due to their size and shape, it is difficult to economically ship such products from their place of manufacture, usually in Asia, to a retailer and their bulk also makes such items less attractive for sale as they occupy significant stocking and display shelf space. Further, as manufacturing has shifted to remote locations where labor costs are less than those in this country, the delivery of relatively low cost items, usually by containers shipped from Asia, has become a larger component of product pricing. This is particularly true as it pertains to the manufacture of non-technical, relatively low end products which rely upon unskilled labor-intensive operations. In addition, retailers have become increasingly cost conscious necessitating the need to maximize shelf space. Products which assume a significant footprint at retail are at a competitive disadvantage.

It is thus an object of the present invention to provide a self grooming device for cats which can be efficiently shipped, stored and displayed and which, prior to use, can be assembled by a consumer providing a self grooming product superior to those currently available.

These and further objects will be more readily apparent when considering the following disclosure and appended claims.

### SUMMARY OF THE INVENTION

A device for facilitating a cat's self grooming. The device includes a pad for residing upon a planar surface and first and second grooming elements. The first and second grooming elements have nodules extending therefrom and each is releasably appended to the pad and to one another such that the grooming elements are selectively detachable from the pad and from each other.

### BRIEF DESCRIPTION OF THE FIGURES

FIG. 1 is a perspective view of the self grooming device of the present invention.

FIG. 2 is the device of FIG. 1 broken down into its individual components intended for shipping, storage and display.

FIG. 3A discloses the interface between individual grooming elements depicting their selected joinder for use in carrying out the present invention.

FIG. 3B discloses the details of the selected joinder of the grooming elements to their support pad in producing the device of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

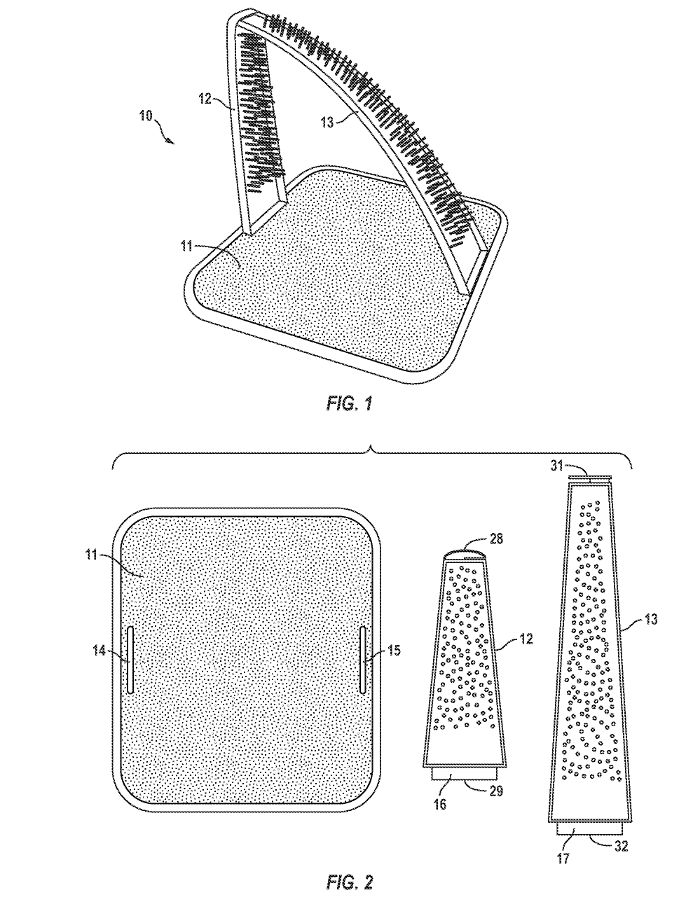

Turning to FIG. 1, self grooming device 10 is shown including pad 11 intended to reside upon a planar, preferably horizontal, surface. Pad 11 can generally be provided with carpet or other cushioning material to encourage a cat to employ self grooming device 10 as intended.

Self grooming device 10 includes first and second grooming elements 11 and 12 each populated by a number of nodules 23. Ideally, such nodules are flexible and pliable ideally composed of rubber or rubber-like cylindrically shaped elements which, again, are of a sufficient length to penetrate a cat's fur and yet be soft and pliable enough so as not to abrade the cat's skin which would discourage a cat's use of the present self grooming device. Thermoplastic resin is an ideal material with nodules in the form of nubs consistent in size, shape and diameter.

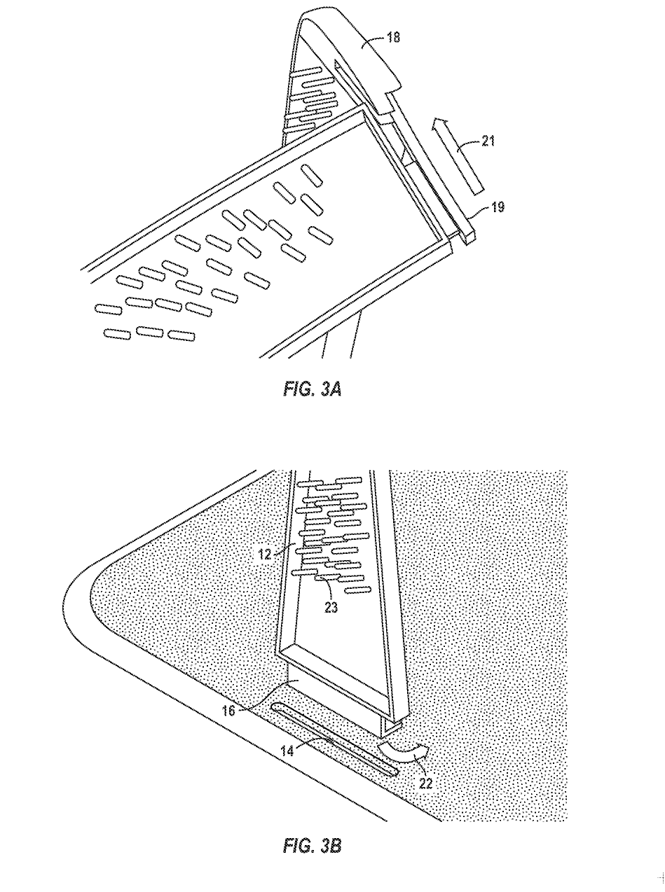

An important feature of the present invention is to provide a consumer with a self grooming device such as depicted in FIG. 1 which is easily assembled at home but which can be shipped and displayed at retail in a much more compact package. To facilitate this goal, reference is made to FIGS. 2, 3A and 3B.

First grooming element 12 and second grooming element 13 having first and second edges 28/29 and 31/32, respectively, are releasably appended to pad 11 and to one another. When doing so, a kit of parts as shown in FIG. 2 is created thus greatly reducing its occupied volume in comparison to assembled device of FIG. 1.

First and second grooming elements 12 and 13 can be appended to and disassembled from one another through the use of tongue 19 and groove 18 without the need for any tools or assembling expertise. Thus, as illustrated, tongue 19 is aligned with groove 18 and pushed in the direction of arrow 21 to complete the joinder of these parts. Each grooming element is also provided with an L-shaped member shown as elements 16 and 17 in FIG. 2. These parts can be aligned with slots 14 and 15 of pad 11 and as illustrated in FIG. 3B, slid into retaining position in the direction of arrow 22 to complete the assembly.

As a preferred embodiment, it is noted that first grooming element 12 is substantially linear and second grooming element 13 is substantially curved. This provides a pet with a substantially vertically oriented set of nodules (first grooming element 12) and a sloping set of nodules (second grooming element 13) to assist the animal in satisfying its grooming needs.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A device for facilitating a cat's self grooming, said device comprising a pad for residing upon a planar surface and first and second grooming elements, said first and second grooming elements having nodules extending therefrom and each releasably appended to said pad and to one another such that said grooming elements are selectively detachable from said pad and from one another.

2. The device of claim 1 wherein each of said grooming elements comprise a first end and a second end, said first ends being releasably attached to said pad and said second ends having a tongue and groove interface to facilitate selected joinder of the second ends.

3. The device of claim 2 wherein said first ends of said grooming element comprise L-shaped members and said pad comprising slots sized to receive said L-shaped members to facilitate selected joinder of the grooming elements to the pad.

4. The device of claim 1 wherein said first grooming element is substantially linear and said second grooming element is substantially curved.

5. The device of claim 1 wherein said grooming elements comprise a thermoplastic resin, said nodules being of a substantially consistent size, shape and diameter.
